(19) United States
(12) Patent Application Publication
(10) Pub. No.: US 2014/0257917 A1
(43) Pub. Date: Sep. 11, 2014

(54) Risk Management System for Calculating Residual Risk of a Process

(71) Applicant: BANK OF AMERICA CORPORATION, Charlotte, NC (US)

(72) Inventors: Frederick Spencer, Hillsborough, NJ (US); Kashyap P. Bhatia, Union City, NJ (US); Glenn E. Gribble, New York, NY (US); Sabine Jerome-Paillant, Valley Stream, NY (US); Peter Macchio, Manhasset, NY (US)

(73) Assignee: Bank of America Corporation, Charlotte, NC (US)

(21) Appl. No.: 13/793,652

(22) Filed: Mar. 11, 2013

(51) Int. Cl. G06Q 10/06

(52) U.S. Cl. CPC G06Q 10/0635
USPC 705/7.28

(57) ABSTRACT

According to one embodiment, a system includes a processor and an interface. The processor determines an entity, a plurality of process groupings associated with the entity, a plurality of processes associated with the entity, a plurality of risks associated with the entity, and a plurality of controls associated with the entity. For each of the controls, the processor calculates one or more weighted control scores for the control. For each of the risks, the processor calculates an inherent risk score for the risk and a residual risk score for the risk. For each of the processes, the processor calculates a residual risk score for the process. The interface communicates for display, for each of the process groupings, an image representing the process grouping. The interface further communicates for display, for each of the processes, an image representing the process and an indication of the residual risk score for the process.

### TECHNICAL FIELD

This disclosure relates generally to the field of risk calculation and more specifically to a risk management system for calculating residual risk of a process.

### BACKGROUND

In order to understand one or more risks associated with an entity and/or a process, information regarding each of the risks is typically collected from one or more different locations (such as one or more different documents, spreadsheets, etc.). Such typical procedures, however, may be burdensome.

### SUMMARY OF THE DISCLOSURE

According to one embodiment, a system includes a processor and an interface. The processor determines an entity, a plurality of process groupings associated with the entity, a plurality of processes associated with the entity, a plurality of risks associated with the entity, and a plurality of controls associated with the entity. For each of the controls, the processor calculates one or more weighted control scores for the control. For each of the risks, the processor calculates an inherent risk score for the risk and a residual risk score for the risk. For each of the processes, the processor calculates a residual risk score for the process. The interface communicates for display, for each of the process groupings, an image representing the process grouping. The interface further communicates for display, for each of the processes, an image representing the process and an indication of the residual risk score for the process.

Certain embodiments of the disclosure may provide one or more technical advantages. For example, the residual risk score for a process may be calculated and communicated for display. Therefore, a user may be able to understand the severity of risks (and how the severity of those risks may be mitigated by one or more controls) of a process. As another example, the process groupings, processes, and the indications of the residual risk score for the processes may all be displayed in a single graphical user interface. Therefore, a user may be able to understand the risks associated with a process with minimal effort.

Certain embodiments of the disclosure may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present disclosure and its features and advantages, reference is now made to the following description, taken in conjunction with the accompanying drawings, in which:

FIG. 1 illustrates a system for calculating residual risk scores;

FIGS. 2A-2E illustrate an example display according to one embodiment of the present disclosure; and

FIG. 3 illustrates another example display according to one embodiment of the present disclosure.

### DETAILED DESCRIPTION OF THE DRAWINGS

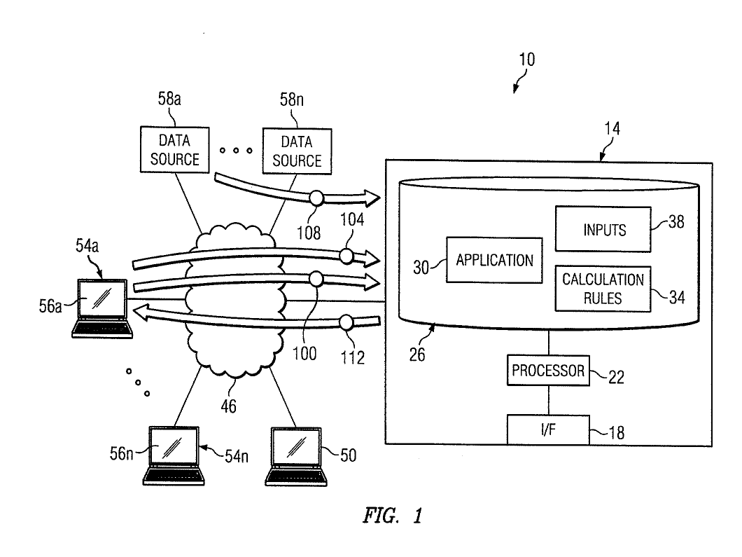

Embodiments of the present disclosure are best understood by referring to FIGS. 1 through 3 of the drawings, like numerals being used for like and corresponding parts of the various drawings.

FIG. 1 illustrates a system 10 for calculating residual risk scores. For example, system 10 may calculate a residual risk score for a process associated with an entity and/or may calculate a residual risk score for the entity. As illustrated, system 10 includes a calculation device 14 that calculates the residual risk scores. Calculation device 14 may further communicate for display an indication of the residual risk scores. For example, calculation device 14 may communicate for display an indication of the residual risk score for the process associated with the entity and/or an indication of the residual risk for the entity. Calculation device 14 may also determine a plurality of process groupings associated with the entity and a plurality of processes associated with the entity, and may further communicate for display an image representing the determined process and an image representing the process grouping, in particular embodiments.

By conducting such determinations and calculations, and communicating them for display, calculation device 14 may allow a user to understand one or more risks associated with an entity and/or a process. For example, such a display may allow a user to understand the severity of risks (and how the severity of those risks may be mitigated by one or more controls) of an entity and/or a process, in particular embodiments. Furthermore, such a display may provide a single graphical user interface that may be updated in near real time, thereby allowing the user to understand such risks with minimal effort, and further allowing the user to make changes and understand how those changes may effect the risks.

Calculation device 14 represents any components that calculate residual risk scores. Calculation device 14 may include a network server, any remote server, a mainframe, a host computer, a workstation, a web space server, a personal computer, a file server, or any other device operable to calculate residual risk scores. The functions of calculation device 14 may be performed by any combination of one or more servers or other components at one or more locations. In the embodiment where the module is a server, the server may be a private server, and the server may be a virtual or physical server. The server may include one or more servers at the same or remote locations. Also, calculation device 14 may include any component that functions as a server. In the illustrated embodiment, calculation device 14 includes a network interface 18, a processor 22, and a memory 26.

Network interface 18 represents any device operable to receive information from network 46, transmit information through network 46, perform processing of information, communicate to other devices, or any combination of the preceding. For example, network interface 18 may receive information from a data source 58. As another example, network interface 18 may communicate indications of residual risk scores for display on a user device 54. Network interface 18 represents any port or connection, real or virtual, including any suitable hardware and/or software, including protocol conversion and data processing capabilities, to communicate through a local area network (LAN), a metropolitan area network (MAN), a wide area network (WAN), or other communication system that allows calculation device 14 to exchange information with network 46, administration device 50, user devices 54, data sources 58, or other components of system 10.

Processor 22 communicatively couples to network interface 18 and memory 26, and controls the operation and administration of calculation device 14 by processing information received from network interface 18 and memory 26. Processor 22 includes any hardware and/or software that operates to control and process information. For example, processor 22 executes calculation device management application 30 to control the operation of calculation device 14. Processor 22 may be a programmable logic device, a microcontroller, a microprocessor, any processing device, or any combination of the preceding.

Memory 26 stores, either permanently or temporarily, data, operational software, or other information for processor 22. Memory 26 includes any one or a combination of volatile or non-volatile local or remote devices suitable for storing information. For example, memory 26 may include random access memory (RAM), read only memory (ROM), magnetic storage devices, optical storage devices, or any other information storage device or a combination of these devices. While illustrated as including particular modules, memory 26 may include any information for use in the operation of calculation device 14.

In the illustrated embodiment, memory 26 includes calculation device management application 30, calculation rules 34, and inputs 38. Calculation device management application 30 represents any suitable set of instructions, logic, or code embodied in a computer readable storage medium and operable to facilitate the operation of calculation device 14.

Calculation rules 34 represent any information that may be used to calculate residual risk scores. Examples of calculation rules 34 are discussed below. Calculation rules 34 may be provided to calculation device 14 in any suitable manner. For example, a user (using the administration device 50 or the user device 54) may create and provide calculation rules 34 to calculation device 14 in order for them to be used to calculate the residual risk scores.

Inputs 38 represent any information that may be provided to calculation device 14. Examples of inputs 38 are discussed below. Inputs 38 may be provided to calculation device 14 in any suitable manner. For example, a user (using the administration device 50 or the user device 54) may provide inputs 38 to calculation device 14 in order for them to be used to calculate the residual risk scores.

Network 46 represents any network operable to facilitate communication between the components of system 10, such as calculation device 14, administration device 50, user devices 54, and data sources 58. Network 46 may include any interconnecting system capable of transmitting audio, video, signals, data, messages, or any combination of the preceding. Network 46 may include all or a portion of a public switched telephone network (PSTN), a public or private data network, a LAN, a MAN, a WAN, a local, regional, or global communication or computer network, such as the Internet, a wireline or wireless network, an enterprise intranet, or any other communication link, including combinations thereof, operable to facilitate communication between the components.

Administration device 50 represents any components that allow a user of the administration device 50 (such as an administrator) to control calculation device 14 and/or provide information to calculation device 14 (such as provide calculation rules 34 and/or inputs 38 to calculation device 14). Administration device 50 may include a personal computer, a workstation, a laptop, a wireless or cellular telephone, an electronic notebook, a personal digital assistant, or any other device (wireless, wireline, or otherwise) capable of receiving, processing, storing, and/or communicating information with other components of system 10 in order to allow a user to control calculation device 14 and/or provide information to calculation device 14. Administration device 50 may comprise a user interface, such as a display, a microphone, keypad, or other appropriate terminal equipment usable by a user.

User device 54 represents any components that may display information received from calculation device 14. User device 54 may include a personal computer, a workstation, a laptop, a wireless or cellular telephone, an electronic notebook, a personal digital assistant, or any other device (wireless, wireline, or otherwise) capable of receiving, processing, storing, and/or communicating information with other components of system 10 in order to display information received from calculation device 14. User device 54 may further allow a user to request information from calculation device 14 and/or provide information to calculation device 14. For example, in order to understand one or more risks associated with an entity, a user may provide one or more inputs 38, a request 100, and/or a selection message 104 to calculation device 14 in order for calculation device to calculate residual risk scores. User device 54 may comprise a user interface, such as a display, a microphone, keypad, or other appropriate terminal equipment usable by a user.

User device 54 may display a graphical user interface 56 in order to allow a user to view the information provided by calculation device 14. Graphical user interface 56 may include any graphical interface that allows the user to view information provided by calculation device 14, request information from calculation device 14, and/or provide information to calculation device 14. For example, graphical user interface 56 may allow a user to input one or more pieces of information (such as inputs 38) to transmit to calculation device 14. In particular embodiments, graphical user interface 58 may be accessible to a user through a web browser.

Although FIG. 1 illustrates system 10 as only including two user devices 54 (user device 54a and user device 54n), system 10 may include any suitable number of user devices 54. For example, system 10 may include less than two user devices 54 or more than two user devices 54.

Data source 58 may represent any source of information that may be used by calculation device 14. Data source 58 may include a device (such as a database, a personal computer, a workstation, a laptop, a wireless or cellular telephone, an electronic notebook, a personal digital assistant, or any other device capable of receiving, processing, storing, and/or communicating information), a person (such as a person who has knowledge of an entity and who provides such knowledge for communication to a calculation device 14), one or more documents (such as a newspaper that includes articles or other information about the entity), the Internet (which may include articles and other information about the entity), an open source intelligence report, a media outlet (such as a television station or a radio station that broadcasts information that may be communicated to calculation device 14), any other suitable source of information, or any combination of the preceding. According to the illustrated embodiment, calculation device 14 may receive information from data sources 58 in order to calculate residual risk scores.

Although FIG. 1 illustrates calculation device 14, administration device 50, user devices 54, and data sources 58 as separate components, in particular embodiments, two or more of the calculation device 14, administration device 50, user devices 54, and data sources 58 may be the same component. For example, the calculation device 14, administration device 50, and user devices 54 may be the same device. As such, a user may view the residual risk scores and/or transmit inputs 38 at the same device that calculates the residual risk scores. As another example, data sources 58 may be the same device as user devices 54. As such, calculation device 14 may receive information from the same device that displays the residual risk scores.

In an example embodiment of operations, in order to understand risks (and the mitigation of such risks) for an entity and/or a process, a user may transmit a request 100 to calculation device 14. Request 100 may represent a request for any suitable calculation and may include any suitable information to facilitate calculation of data by calculation device 14. For example, request 100 may include a request for a residual risk score for an entity, a residual risk score for a process associated with an entity, a graphical representation of the processes associated with an entity, and/or any other suitable request.

In response to receiving request 100, calculation device 14 may perform any type of calculation for residual risk scores. As an example, calculation device 14 may calculate residual risk score for an entity and/or a residual risk score for a process associated with an entity. In order to do so, calculation device 14 may conduct various steps (discussed below). Additionally, in order to perform one or more of the following steps, calculation device 14 may further receive selection message 104 and information 108, in particular embodiments. Selection message 104 may represent any type of selection made by a user in order to allow calculation device 14 to calculate residual risk scores. For example, selection message 104 may represent a user's selection of a particular impact score for a risk (discussed below). Furthermore, although FIG. 1 illustrates selection message 104 as having been received from user device 54a, in particular embodiments, selection message 104 may have been received from any of the user devices 54, any of the data sources 58, administrative device 50, and/or from an input directly into calculation device 14 (such as by a keyboard of calculation device 14). Information 108 may include any information received from data sources 58 and used by calculation device 14 to calculate residual risk scores. For example, information 108 may include one or more reports from experts on the entity, one or more articles regarding the entity, one or more television and/or radio reports regarding the entity, and/or any other type of information regarding the entity.

Based at least on the information discussed above, calculation device 14 may perform one or more of the following steps. Calculation device 14 may perform each of the following steps, or may perform only a portion of the following steps, in particular embodiments. Furthermore, although the following steps are illustrated below as occurring in response to receiving request 100, in particular embodiments, one or more of the following steps may occur prior to receiving request 100.

First, calculation device 14 may determine an entity. An entity represents any suitable entity that may be conducting business, may be conducting one or more activities, or may have one or more risks associated with it. For example, the entity may include a person, a business, a corporation, a financial institution (e.g., such as a bank), or any other suitable entity. An entity may further include one or more sub-entities of an entity. For example, an entity may include one or more sub-corporations, divisions, business units, offices, regions, or any other portions of a larger entity. Calculation device 14 may determine the entity in any suitable manner. For example, calculation device 14 may determine the entity based on inputs 38. As such, calculation device 14 may determine the entity by accessing inputs 38 in memory 26. As another example, calculation device 14 may determine the entity based on information 108 received from data sources 58. In such an example, in order to determine the entity, calculation device 14 may query one or more data sources 58 to receive the entity and/or information that identifies the entity. As another example, calculation device 14 may determine the entity based on information received from request 100 and/or selections made in selection message 104. In such an example, if request 100 requests a residual risk score for company XYZ, calculation device 14 may determine the entity to be company XYZ.

Second, calculation device 14 may determine processes associated with the entity and process groupings associated with the entity. A process associated with an entity represents an activity of a portion of the entity. For example, company XYZ may sell a product. As such, processes associated with company XYZ may include, for example: (1) manufacturing the product; (2) marketing the product; (3) selling the product; and/or (4) researching future products. A process grouping represents any suitable grouping to which a process may be associated with. For example, a process grouping for company XYZ, may include, for example: (1) current products (which may include the processes: manufacturing the product, marketing the product, and/or selling the product) and (2) future products (which may include the process: researching future products). Other examples of processes and process groupings may include one or more of the following:
Process Grouping 1.0: New Product Development
   Process 1.1: Identify new Products/Services
   Process 1.2: Implement New Products/Services
Process Grouping 2.0: Research
   Process 2.1: Develop Research Analysis
   Process 2.2: Manage Research Distribution
Process Grouping 3.0: Sales & Relationship Management
   Process 3.1: Manage Sales
   Process 3.2: Authorize Client
   Process 3.3: Communicate with Client
   Process 3.4: Establish Client Account
   Process 3.5: Manage Client Interactions
Process Grouping 4.0: Issuance
   Process 4.1: Manage Issuance Lifecycle
   Process 4.2: Track Issuance Revenue
Process Grouping 5.0: Trade/Execution Services
   Process 5.1: Capture & Validate Transactions
   Process 5.2: Analyze & Price Trade
   Process 5.3: Model & Structure Deal
   Process 5.4: Manage Order
   Process 5.5: Manage Execution
   Process 5.6: Manage Quotes & Market Making
   Process 5.7: Develop Valuation & Risk Model
Process Grouping 6.0: P&L Management
   Process 6.1: Establish Valuation Standards
   Process 6.2: Validate & Control Model
   Process 6.3: Verify Trader's Price
   Process 6.4: Value Position
   Process 6.5: Produce P&L
   Process 6.6: Explain P&L
   Process 6.7: Attribute P&L
Process Grouping 7.0: Transaction Processing
   Process 7.1: Enrich/Figure Transactions
   Process 7.2: Allocation to Sub Accounts
   Process 7.3: Process Confirms/Affirms
   Process 7.4: Match Transactions (External)
Process Grouping 8.0: Settlement & Cash Payments
   Process 8.1: Receive/Deliver
   Process 8.2: Manage Balances
   Process 8.3: Manage Vault & Physical Instruments
   Process 8.4: Process Payments & Receipts
   Process 8.5: Manage Standing Account Instructions
Process Grouping 9.0: Asset Servicing
   Process 9.1: Manage Corporate Actions
   Process 9.2: Margin & Segregate Securities
   Process 9.3: Manage Custody/Safekeeping
   Process 9.4: Transfer Client Assets
   Process 9.5: Manage Loan Servicing
Process Grouping 10.0: Finance Services
   Process 10.1: Manage Securities Lending
   Process 10.2: Manage Cash/Funding
   Process 10.3: Manage Collateral Operations
Process Grouping 11.0: Accounting Services
   Process 11.1: Manage Ledger & Stock Records
   Process 11.2: Manage Financial Records
Process Grouping 12.0: Information/Data Management
   Process 12.1: Manage Access & Entitlement
   Process 12.2: Manage Data Standards
   Process 12.3: Manage Data & Calendar Data
   Process 12.4: Manage Changes
   Process 12.5: Manage Capacity
   Process 12.6: Manage Incidents
   Process 12.7: Manage Data & Feeds
Process Grouping 13.0: Risk Management
   Process 13.1: Set Risk Management Policies
   Process 13.2: Define Risk Scenarios
   Process 13.3: Report Consolidated Risk
   Process 13.4: Manage Credit Limits/Hierarchies
   Process 13.5: Manage Trading Limits (Internal)
   Process 13.6: Manage Market Risk
   Process 13.7: Manage Credit Risk
   Process 13.8: Manage Operational Risk
Process Grouping 14.0: Management & Control Services
   Process 14.1: Provide Legal Services
   Process 14.2: Manage Compliance
   Process 14.3: Produce Financial, Tax & Reg Reports
   Process 14.4: Manage Client Documents
   Process 14.5: Manage Supplier Relationship
   Process 14.6: Set Compliance Policy
Process Grouping 15.0: HR
   Process 15.1: Grow & Develop Associates
   Process 15.2: Manage Needs for Staff
   Process 15.3: Pay & Reward Associates
   Process 15.4: Manage Workplace
Process Grouping 16.0: Business Continuity Planning
   Process 16.1: Develop Plans
   Process 16.2: Communicate Plans
   Process 16.3: Test Plans
   Process 16.4: Remediate Gaps
Process Grouping 17.0: Manage External Events & Risks
   Process 17.1: Manage LOB/Industry Specific Risks & Situational Events
   Process 17.2: Manage Macro Level—Risks, External Events, & Changes to External Environment
Process Grouping 18.0: Legal Entity Processes
   Process 18.1: Process for Legal Entity A
   Process 18.2: Process for Legal Entity B
   Process 18.3: Process for Legal Entity C
   Process 18.4: Process for Legal Entity D
Process Grouping 19.0: Governance & Oversight
   Process 19.1: Governance Meetings

Although particular types of processes and process groupings and a particular number of processes and process groupings have been discussed above, any other type of processes and process groupings and any other number of processes and process groupings may be included in system 10 of FIG. 1.

Calculation device 14 may determine the processes and process groupings in any suitable manner. For example, calculation device 14 may determine one or more of the processes and process groupings based on inputs 38. As another example, calculation device 14 may determine one or more of the processes and process groupings based on information 108 received from data sources 58. As another example, calculation device 14 may determine one or more of the processes and process groupings based on information received from request 100 and/or selections made in selection message 104.

Third, calculation device 14 may determine risks associated with the entity. A risk represents the entity's potential exposure to loss. For example, the risk may be the entity's potential exposure to loss as a result of inadequate or failed processes, systems, and/or events. A risk may be associated with at least one process, in particular embodiments. For example, the risk may be a potential exposure to loss based on the process associated with the entity. In such an example, risks associated with company XYZ's process of manufacturing a product may include, for example: (1) lack of supplies for manufacturing the product; and (2) lack of manufacturing capability. Each of these risks associated with the process of manufacturing a product may potentially expose company XYZ to loss.

Other examples of risk may include: (1) global market risks (such as risks associated with creating a new product, trading a new product, selling a new product, settling a transaction with a counterparty, etc.); (2) entity specific and/or situational event driven risks (such as risks associated with a problem with the entity's technology or trading system, etc.); (3) macro level risks, external events, and changes to external environment (such as a geo-political risk, severe weather risk, global economy downturn risks, etc.); (4) legal entity specific risks (such as a risk dealing with jurisdictional issues, etc.); (5) and/or governance and oversight specific risks (such as a risk associated with Sarbanes-Oxley, etc.). Additional examples of risks may include:
Aged audit issues
Associates may not be aware of certain requirements
Compliance personnel not adequately trained
Compliance-related controls not tested
Counterparty exposure
Critical rules not identified
Cyber attack
Defects in data quality
Exceeding capacity thresholds
Exposure to litigation
Extended settlements
Failure to provide legal advice/counseling
Failure to follow protocol
Inaccurate records
Inadequate testing
Invalid payment details
Not able to access policies and procedures
Physical security of vaults
Supplier risk
Valuations and risk models are inaccurate
Vendor performance issues
Vendors operating without contracts

Although particular types of risks and a particular number of risks have been discussed above, any other type of risks and any other number of risks may be included in system 10 of FIG. 1.

Calculation device 14 may determine the risks in any suitable manner. For example, calculation device 14 may determine one or more of the risks based on inputs 38. As another example, calculation device 14 may determine one or more of the risks based on information 108 received from data sources 58. As another example, calculation device 14 may determine one or more of the risks based on information received from request 100 and/or selections made in selection message 104. Determining a risk may further include determining information associated with the risk, in particular embodiments. For example, determining the risk may include determining a description of the risk, a definition of the risk, an evaluator of the risk, how the risk is applied to the entity, and/or any other suitable information regarding the risk. Such determinations may be made based on inputs 38, information 108 received from data sources 58, information received from request 100, and/or information received from selection message 104.

Fourth, calculation device 14 may determine controls associated with the entity. A control represents any suitable strategy and/or activity for mitigating a portion of a risk. For example, if a particular risk to an entity is high, a control may be enacted in order to mitigate a portion of that risk, such as, for example, mitigate the risk from high to moderate or low. A control may be associated with a particular risk. As an example, in order to mitigate the risk of lack of supplies for manufacturing a product, company XYZ may enact a control that provides for a six-month inventory stockpile of supplies. In such an example, when conditions create a high risk of lack of supplies, such a control may mitigate the high risk, potentially causing it to be a moderate or low risk. Although a control may be configured to mitigate a portion of a risk, in particular embodiments, the control may not actually mitigate the risk at all. For example, if supplies for manufacturing a product become completely unavailable for the next few years, a control that provides for a six-month inventory stockpile of supplies may not reduce the risk of lack of supplies at all (i.e., the risk may still be “high”).

Other examples of controls may include:
Independent review and sign-off of maintenance
Approve journal entries
Focus review meeting
Review new hire procedures
Review risk scenarios
Compliance policies and procedures
Price verification coverage and escalation routines
Templates approved by legal
Vendor/External owned systems performance is monitored and tracked
Testing of all company codes
Independent review of all maintenance
Negotiation of confidentiality agreements
Review client documentation
Report trading attributes
Compliance risk assessment
Compliance roles
Business recovery plans updated
Daily balance comparison
Review of training needs
Make employees aware of new/revised policies
Review audit issues

Although particular types of controls and a particular number of controls have been discussed above, any other type of controls and any other number of controls may be included in system 10 of FIG. 1.

Calculation device 14 may determine the controls in any suitable manner. For example, calculation device 14 may determine one or more of the controls based on inputs 38. As another example, calculation device 14 may determine one or more of the controls based on information 108 received from data sources 58. As another example, calculation device 14 may determine one or more of the controls based on information received from request 100 and/or selections made in selection message 104. Determining a control may further include determining information associated with the control, in particular embodiments. For example, determining the control may include determining a description of the control, a definition of the control, an evaluator of the control, an owner of the control, how the control is applied to the risk, and/or any other suitable information regarding the control. Such determinations may be made based on inputs 38, information 108 received from data sources 58, information received from request 100, and/or information received from selection message 104.

Fifth, for one or more of the controls, calculation device 14 may determine a design rating score for the control and a performance rating score for the control. The design rating score for a control represents an indication of how well the control is designed. For example, if a control provides for a six-month inventory stockpile of supplies for a product, but the control is associated with a risk that there will be a lack of supplies for more than one year, the control may have been designed poorly (i.e., providing only a six-month supply when one year is needed). The performance rating score for the control represents an indication of how well the control is performing. For example, if a control provides for a six-month inventory stockpile of supplies, but information indicates that there will be a supply shortage for only three months, the control may be performing well (i.e., it provides a six-month inventory stockpile of the supplies when the risk of lack of supplies is only for three months).

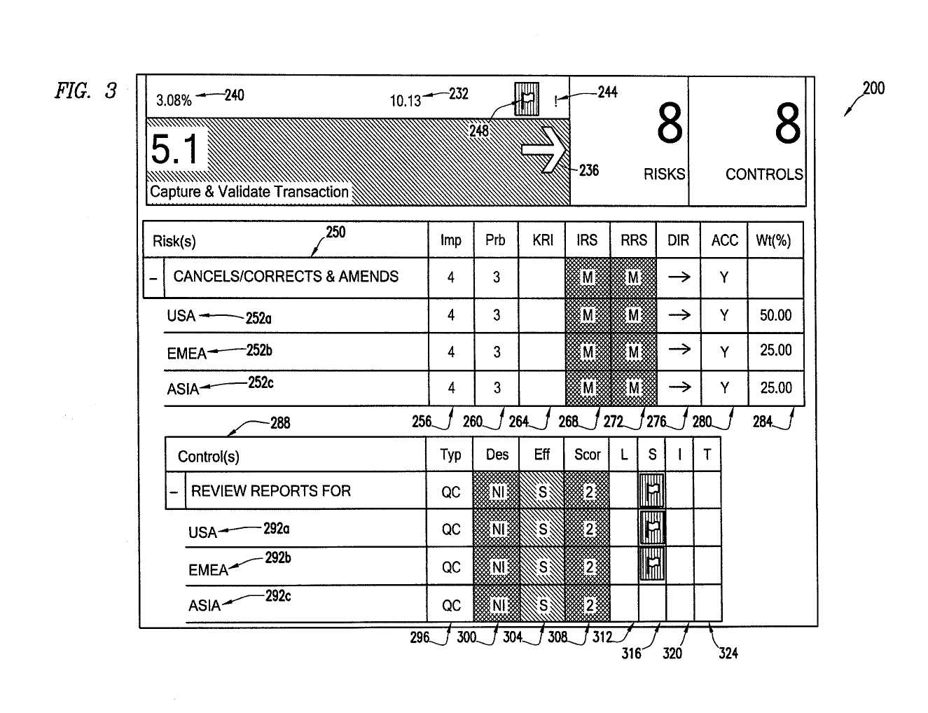

The design rating score and the performance rating score may include any suitable indicator of a score. For example, the design rating score and the performance rating score may be a numerical score, an alphabetical score (i.e., A, B, C), a level (i.e., satisfactory, unsatisfactory, needs improvement), or any other suitable type of indicator of a score. According to the illustrated embodiment, the design rating score and the performance rating score may be a level, such as satisfactory (S), unsatisfactory (U), and/or needs improvement (NI). Examples of the design rating score and the performance rating score may be seen in columns 300-304 of FIG. 3.

Calculation device 14 may determine the design rating score and the performance rating score in any suitable manner. For example, calculation device 14 may determine design rating score and the performance rating score based on inputs 38. As another example, calculation device 14 may determine design rating score and the performance rating score based on information 108 received from data sources 58. In such an example, if a forecast report for company XYZ indicates that supplies for a product will be abundant for the next year, calculation device 14 may analyze the forecast report and determine that the design rating score and the performance rating score for a control that provides for a six-month inventory stockpile of the supplies is satisfactory to mitigate the risk of lack of supplies for manufacturing the product. As another example, calculation device 14 may determine one or more of the controls based on information received from request 100 and/or selections made in selection message 104. In such an example, a selection message 104 (from a user using user device 54 or administration device 50) may include a selection of needs improvement (NI) for the design rating score of a control, and a selection of satisfactory (S) for the performance rating score for a control.

Calculation device 14 may determine the design rating score and the performance rating score for a control (or a user may select the design rating score and the performance rating score) based on any suitable data for a control. An example of such data may include, for example, losses (L), issues (S), indicators (I), and test results (T) for a control (examples of which may be seen in columns 312-324 of FIG. 3). In such an example, the design rating score and the performance rating score may be based on a determination regarding whether or not there are losses associated with the control (such as a portion of the supplies in the six-month inventory stockpile is going bad), issues associated with the control (such as there is not enough space for an inventory stockpile of six months in the selected storage area), indicators associated with the control (such as a key control indicator that indicates whether the six-months inventory stockpile of supplies has been completed, is on schedule to be completed, or is behind schedule to be completed), and test results associated with the control (such as an indication that the quality assurance of the six-month inventory stockpile has failed because nobody has been checking to make sure that the supplies are the proper type of supplies). In particular, in order to select the design rating score and the performance rating score, the user may review documents that indicate the losses, issues, indicators and test results associated with the control. Additionally, in order for calculation device 14 to determine the design rating score and the performance rating score for a control, calculation device 14 may analyze information received from, for example, data sources 58 that indicates whether or not there are any losses, issues, indicators, and/or test results associated with the control. Calculation device 14 may determine whether there are any losses, issues, indicators, and/or test results associated with the control (and may determine any information about the losses, issues, indicators, and/or test results) based on inputs 38, information 108 received from data sources 58, information received from request 100, and/or selections made in selection message 104.

Sixth, for one or more of the controls, calculation device 14 may calculate a rating score for the control. The rating score for the control may represent a rating for the control based on its design rating score and its performance rating score. For example, the rating score for the control may be a poor rating score if the control has both a design rating score of unsatisfactory and a performance rating score of unsatisfactory. As another example, the rating score for the control may be a good rating score if the control has both a design rating score of satisfactory and a performance rating score of satisfactory. Examples of the rating score for the control may be seen in column 308 of FIG. 3.

Calculation device 14 may calculate the rating score for the control using calculation rules 34. The rating score for the control may be calculated using any suitable rule in calculation rules 34. For example, the rating score for a control may be calculated based on the following calculations rules 34:

| Design | Performance | Rating Score | Environment Score |
|---|---|---|---|
| Rating Score | Rating Score | for the Control | for the Control |
| Satisfactory | Satisfactory | 1 | Satisfactory |
| Needs | Satisfactory | 2 | Needs |
| Improvement | | | Improvement |
| Satisfactory | Needs | 2 | Needs |
| | Improvement | | Improvement |
| Needs | Needs | 3 | Needs |
| Improvement | Improvement | | Improvement |
| Unsatisfactory | Satisfactory/ | 4 | Unsatisfactory |
| | Needs | | |
| | Improvement | | |
| Satisfactory/ | Unsatisfactory | 4 | Unsatisfactory |
| Needs | | | |
| Improvement | | | |
| Unsatisfactory | Unsatisfactory | 5 | Unsatisfactory |

As an example of a calculation performed according to the above calculation rules 34, when the design rating score for a control is satisfactory or needs improvement, and the performance rating score for the control is unsatisfactory, calculation device 14 may calculate the control as having a rating score of 4. Although the rating score is described above as being a numerical value, in particular embodiments, the rating score may further be a description (i.e., satisfactory, unsatisfactory, needs improvement). As an example, an environment score for the control (illustrated in the above calculations rules 34) may represent the rating score as a description. In such an example, when the design rating score for a control is satisfactory or needs improvement, and the performance rating score for the control is unsatisfactory, calculation device 14 may calculate the control as having an environment score of unsatisfactory.

Although the example embodiment has described calculation rules 34 as including particular rules for calculating a rating score (and/or an environment score) for a control, any other suitable rules may be used to calculate the rating score (and/or the environment score). For example, the design rating score for a control and the performance rating score for the control may be numerical values, and the rating score for the control may be calculated as an average of such numerical values.

Seventh, for one or more of the controls, calculation device 14 may determine a control weight for the control. The control weight for the control represents the weight that is allocated to the control for mitigating a portion of a risk. For example, in order to mitigate the risk of a lack of supplies for a product, two different controls may be implemented: (1) six-month inventory stockpile of the supplies; and (2) reduce the waste of supplies during manufacturing. In such an example, the control that provides for a six-month inventory stockpile of the supplies may be more important to mitigating the risk than the control that provides for reducing the waste of supplies during manufacturing. As such, the control that provides for a six-month inventory stockpile of the supplies may be weighted at 75%, while the control that provides for reducing the waste of supplies during manufacturing may only be weighted at 25% (i.e., for a total of 100%).

Calculation device 14 may determine the control weight for the control in any suitable manner. For example, calculation device 14 may determine the control weight for the control based on inputs 38. As another example, calculation device 14 may determine the control weight for the control based on information 108 received from data sources 58. As another example, calculation device 14 may determine the control weight for the control based on information received from request 100 and/or selections made in selection message 104.

Eighth, for one or more of the controls, calculation device 14 may calculate one or more weighted control scores for the control. The weighted control score represents the ability of the control to mitigate a portion of a particular risk. Calculation device 14 may calculate the weighted control score for the control using calculation rules 34. The weighted control score for the control may be calculated using any suitable rule in calculation rules 34. For example, the weighted control score for the control may be calculated based on the following calculations rule 34:

C=Sᵣ*Wₑ (1)
wherein C is the weighted control score for the control
wherein Sᵣ is the rating score for the control
wherein W_{c} is the control weight for the control

As an example, when a control has a rating score of 4 and a control weight of 75%, the weighted control score for the control is 3 (4*0.75=3). Furthermore, although the example embodiment has described calculation rules 34 as including a particular rule for calculating a weighted control score for a control, any other suitable rule may be used to calculate the weighted control score.

As is discussed above, calculation device 14 may calculate one or more weighted control scores for the control. The one or more weighted control scores for a control may include any suitable number of weighted control scores, in particular embodiments. For example, if a control is implemented over various regions (such as in the United States of America (“USA”), Europe, the Middle East, and Africa (“EMEA”), Asia, etc.), a weighted control score may be calculated for each of the regions in which the control is implemented (as is discussed in further detail below with regard to region scores for the control). In such an example, the one or more weighted control scores may include the weighted control scores (otherwise referred to below as region scores) in each of the regions in which the control is implemented.

Ninth, for one or more of the risks, calculation device 14 may determine an impact score for the risk and a probability score for the risk. The impact score represents an indication of a result associated with an occurrence of the risk. For example, if company XYZ were to run out of supplies for manufacturing a product, company XYZ may be greatly impacted. As such, the impact score for the risk of lack of supplies for manufacturing a product may be high. The probability score for the risk represents an indication of the probability associated with the occurrence of the risk. For example, if the supplies for the product manufactured by company XYZ are very common, there may be a very low probability associated with running out of supplies for the product. As such, the probability score for the risk of lack of supplies for manufacturing a product may be low.

The impact score for the risk and the probability score for the risk may include any suitable indicator of a score. For example, the impact score for the risk and the probability score for the risk may be a numerical score, an alphabetical score (i.e., A, B, C), a level (i.e., satisfactory, unsatisfactory, needs improvement), or any other suitable type of indicator of a score. According to the illustrated embodiment, the impact score for the risk and the probability score for the risk may be a numerical score (such as, for example, a score of 1-5). In such an example, the impact score for the risk may be determined to be a value of 5 when the impact of the risk is high (or 1 when the impact of the risk is low), and the probability score for the risk may be a value of 5 when the probability associated with the occurrence of the risk is high (or a value of 1 when the probability of occurrence of the risk is low). Examples of the impact score for the risk and the probability score for the risk may be seen in columns 256-260 of FIG. 3.

Calculation device 14 may determine the impact score for the risk and the probability score for the risk in any suitable manner. For example, calculation device 14 may determine the impact score for the risk and the probability score for the risk based on inputs 38. As another example, calculation device 14 may determine the impact score for the risk and the probability score for the risk based on information 108 received from data sources 58. In such an example, if a finance report for company XYZ indicates that Product A is the only profitable product sold by company XYZ, calculation device 14 may analyze the finance report and determine that the impact score for the risk of lack of supplies for manufacturing Product A is the value 5. As another example, calculation device 14 may determine the impact score for the risk and the probability score for the risk based on information received from request 100 and/or selections made in selection message 104. In such an example, a selection message 104 (from a user using user device 54 or administration device 50) may include a selection of the value 5 for the impact score for the risk, and a selection of the value 1 for the probability score for the risk.

Tenth, for one or more of the risks, calculation device 14 may calculate an inherent risk score (IRS) for the risk. The inherent risk score represents an indication of the severity of the risk absent any controls. For example, the inherent risk score for the risk of lack of supplies for manufacturing a product represents an indication of the severity of such a risk if there were no controls implemented to mitigate that risk (such as if the following controls were not ever implemented: (1) six-month inventory stockpile of the supplies; and (2) reduce the waste of supplies during manufacturing).

Calculation device 14 may calculate the inherent risk score for the risk using calculation rules 34. The inherent risk score for the risk may be calculated using any suitable rule in calculation rules 34. For example, the inherent risk score for the risk may be calculated based on the following calculations rule 34:

IRS=I*P (2)
wherein IRS is the inherent risk score for the risk
wherein I is the impact score for the risk
wherein P is the probability score for the risk

As an example, when the impact score for the risk of lack of supplies for manufacturing a product is high (for example, a value of 5) and the probability score for the risk is low (for example, a value of 1), the inherent risk score for the risk is 5 (5*1=5).

Although the inherent risk score for the risk has been discussed above as being a numerical value, in particular embodiments, the inherent risk score may further be calculated as a level (i.e., high, moderate, low). In such embodiments, an inherent risk score less than or equal to 6 may be calculated as a “low” inherent risk score, an inherent risk score greater than 6 and less than 15 may be calculated as a “moderate” inherent risk score, and an inherent risk score greater than or equal to 15 may be calculated as a “high” inherent risk score. Examples of the inherent risk score for the risk may be seen in column 268 of FIG. 3.

Eleventh, for one or more of the risks, calculation device 14 may calculate the residual risk score for the risk. The residual risk score for the risk represents an indication of a severity of the risk when the risk is mitigated by one or more controls. For example, the residual risk score for the risk of lack of supplies for manufacturing the product represents an indication of the severity of the risk when it is mitigated by each of its controls (such as: (1) six-month inventory stockpile of the supplies; and (2) reduce the waste of supplies during manufacturing). Therefore, as effective controls are implemented to mitigate a risk, the residual risk score of that risk may be lowered. On the other hand, a high residual risk score for a risk may be an indication that one or more of the controls associated with the risk are ineffective.

Calculation device 14 may calculate the residual risk score for the risk using calculation rules 34. The residual risk score for the risk may be calculated using any suitable rule in calculation rules 34. For example, the residual risk score for the risk may be calculated based on the following calculations rule 34:

RRSᵣ=(IRS*C₁)+(IRS*C₂)+ . . . (3)
wherein RRSᵣ is the residual risk score for the risk
wherein IRS is the inherent risk score for the risk
wherein C₁ is the weighted control score for the first control implemented to mitigate a portion of the risk
wherein C₂ is the weighted control score for the second control implemented to mitigate a portion of the risk

According to the calculation rule 34 above, the residual risk score for a risk may be calculated based on the number of controls implemented to mitigate the risk. For example, if only one control has been implemented to mitigate the risk, calculation rule 34 may only utilize the weighted control score for that one control. On the other hand, if three controls have been implemented to mitigate that risk, calculation rule 34 may utilize the weighted control score for each of the three controls. As an example of the calculation rule 34 above, when the inherent risk score for a risk (i.e., lack of supplies for manufacturing the product) is 5, the weighted control score for the first control (i.e., six-month inventory stockpile of the supplies) is 5, and the weighted control score for the second control (i.e., reduce the waste of supplies during manufacturing) is 2, the residual risk score for the risk is 35 ((5*5)+(5*2)=35).

Although the residual risk score for the risk has been discussed above as being a numerical value, in particular embodiments, the residual risk score for the risk may further be calculated as a level (i.e., high, moderate, low). For example, a residual risk score less than twelve may be calculated as a “low” residual risk score for the risk, a residual risk score greater than or equal to 12 and less than 75 may be calculated as a “moderate” residual risk score for the risk, and a residual risk score greater than or equal to 75 may be calculated as a “high” residual risk score for the risk. Examples of the residual risk score for the risk may be seen in column 272 of FIG. 3.

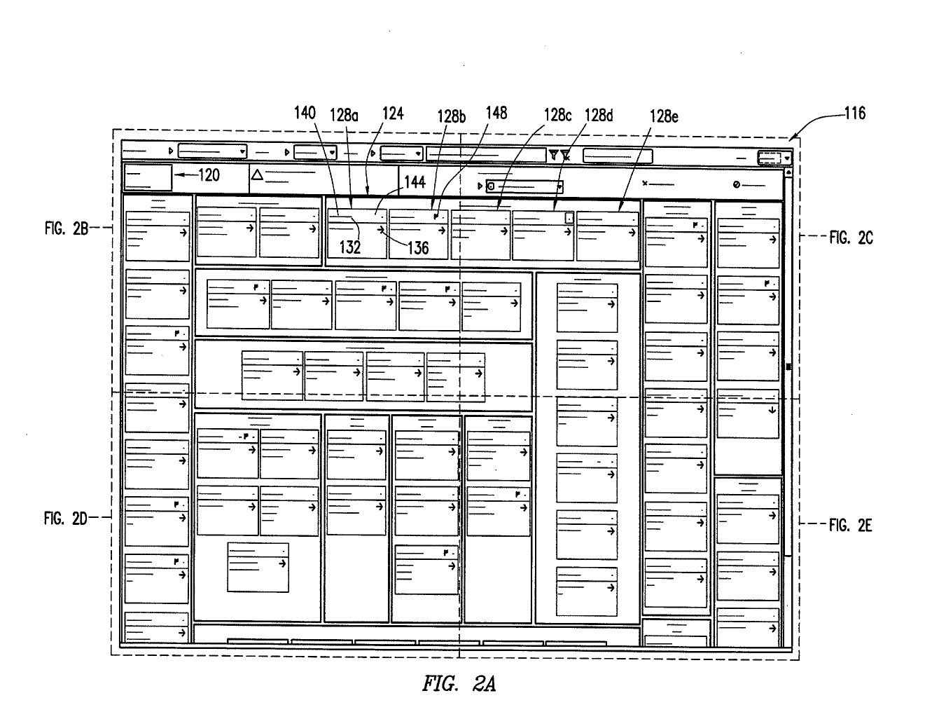

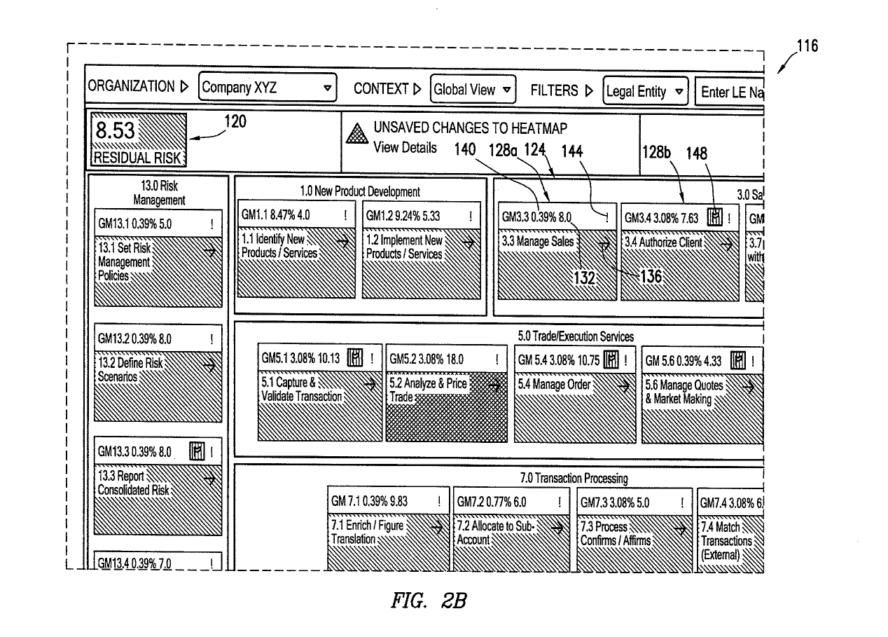

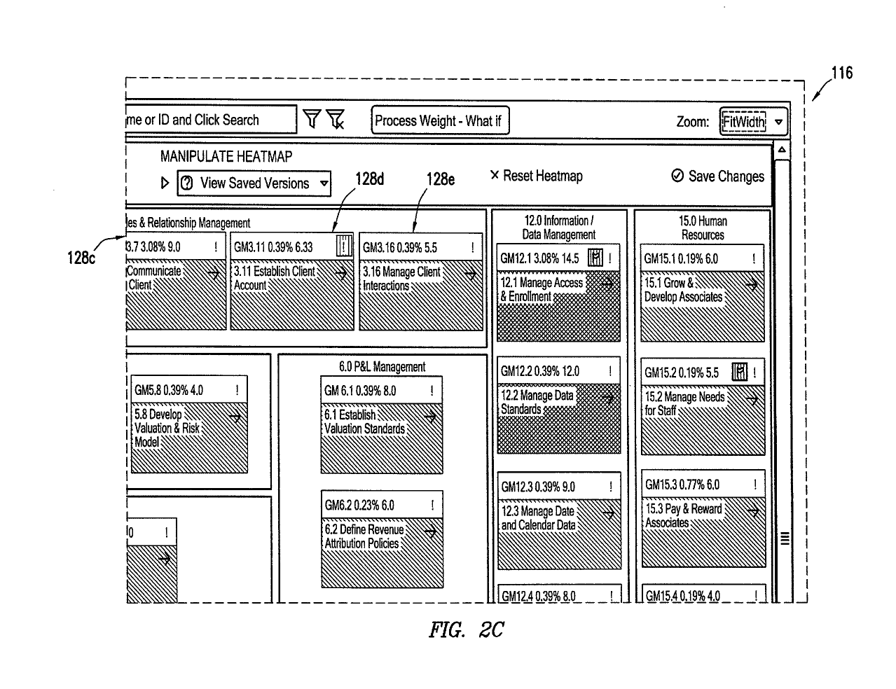

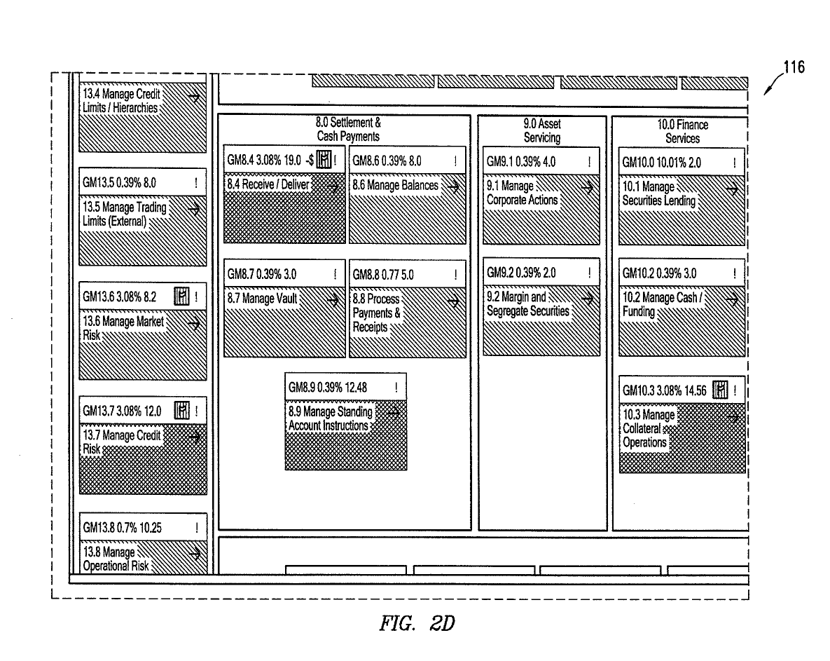

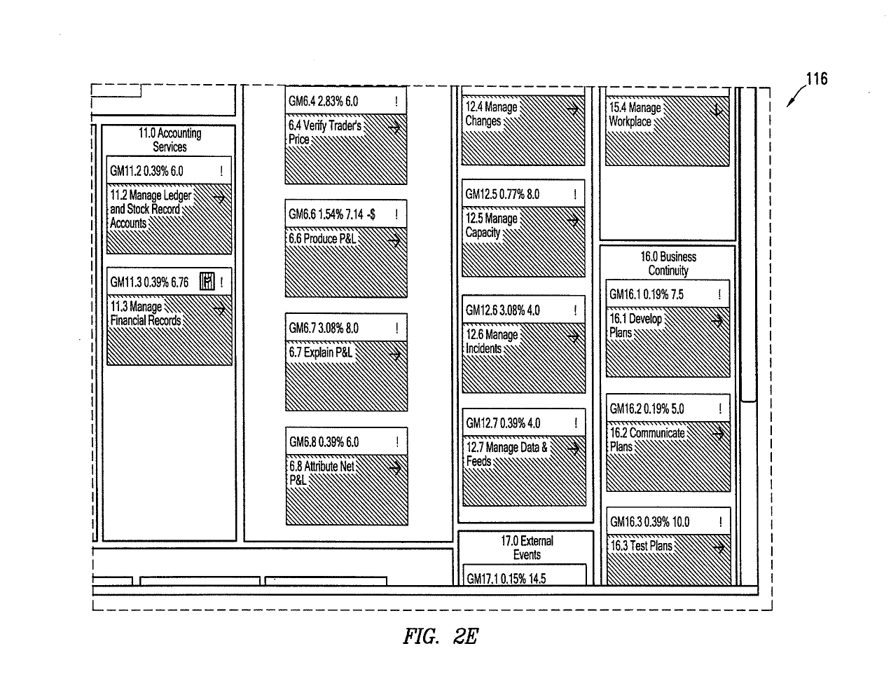

Twelfth, for one or more of the processes, calculation device 14 may calculate a residual risk score for the process. The residual risk for the process represents the severity of risk associated with the process. For example, company XYZ is associated with the process of manufacturing a product. The residual risk score for this process represents the severity of risk associated with the process, which may include the severity of risk of each of the risks associated with the process (i.e., (1) lack of supplies for manufacturing the product; and (2) lack of manufacturing capability). The residual risk score for the process may allow a user to understand one or more risks (and one or more controls that may mitigate those risks) associated with the process, in particular embodiments. Calculation device 14 may calculate the residual risk score for the process using calculation rules 34. The residual risk score for the process may be calculated using any suitable rule in calculation rules 34. For example, the residual risk score for the process may be calculated as an average of each of the residual risk scores of the risks associated with the process. As an example of such a calculation, when the residual risk score for the first risk (i.e., lack of supplies for manufacturing the product) is 40, and the residual risk score for the second risk (i.e., lack of manufacturing capability) is 20, the residual risk score is 30 ((40+20)/2=30). Examples of the residual risk score for a process may be seen at indicator 132 of FIGS. 2A-2E and indicator 232 of FIG. 3.

Although the residual risk score for the process has been discussed above as being a numerical value, in particular embodiments, the residual risk score for the process may further be calculated as a level (i.e., high, moderate, low). For example, a residual risk score for the process less than 12 may be calculated as a “low” residual risk score, a residual risk score for the process greater than or equal to 12 and less than 75 may be calculated as a “moderate” residual risk score, and a residual risk score for the process greater than or equal to 75 may be calculated as a “high” residual risk score. As such, when the residual risk score for the process is 30, the residual risk score for the process may be calculated to be a “moderate” residual risk score for the process.

Thirteenth, for one or more of the processes, calculation device 14 may calculate a trend direction of the residual risk score for the process. A trend direction of the residual risk score for the process represents a direction that the residual risk score for the process is trending towards (i.e., such as the score is increasing, decreasing, or staying consistent). Calculation device 14 may calculate the residual risk score for the process using calculation rules 34. The residual risk score for the process may be calculated using any suitable rule in calculation rules 34. As an example of such a calculation, the trend direction of the residual risk score for the process may be calculated by comparing the current residual risk score for the process to a previous residual risk score for the process. In such an example, when the current residual risk score for the process is 30, but a previous residual risk score for the process was 40, calculation device 14 may calculate the trend direction of the residual risk score for the process as decreasing (i.e., since 30 is less than 40). Examples of the trend direction of the residual risk score for a process may be seen at indicator 136 of FIGS. 2A-2E and indicator 236 of FIG. 3.

Fourteenth, for one or more of the processes, calculation device 14 may determine a process weight associated with the process. The process weight associated with the process represents the weight allocated towards that process for calculating the residual risk score for the entity. For example, if the most important process of company XYZ is the process of manufacturing Product A, this process may have a higher weight than any of the other processes associated with the entity. In such an example, the process of manufacturing the Product A may have a weight of 40%, while all the other processes of company XYZ may each have only a weight of 10%. Examples of the process weight associated with a process may be seen at indicator 140 of FIGS. 2A-2E and indicator 240 of FIG. 3.

Calculation device 14 may determine the process weight associated with a process in any suitable manner. For example, calculation device 14 may determine the process weight associated with a process based on inputs 38. As another example, calculation device 14 may determine the process weight associated with a process based on information 108 received from data sources 58. In such an example, if a finance report for company XYZ indicates that Product A is the only profitable product sold by company XYZ, calculation device 14 may analyze the finance report and determine that the process weight associated with the process of manufacturing Product A is 40%. As another example, calculation device 14 may determine the process weight associated with a process based on information received from request 100 and/or selections made in selection message 104. In such an example, a selection message 104 (from a user using user device 54 or administration device 50) may include a selection of 20% for the process weight associated with a process.

Fifteenth, calculation device 14 may calculate a residual risk score for the entity. The residual risk score for the entity may represent how much risk is associated with an entity (even after mitigation by the controls). For example, if company XYZ includes various processes that have high risks and no effective controls, the residual risk score for the entity may provide an indication that there is a high amount of risk associated with the entity. On the other hand, if company XYZ includes various processes that have high risk (but those risks are effectively mitigated by one or more controls), the residual risk score for the entity may provide an indication that there is a low amount of risk associated with the entity. As such, the residual risk score for the entity may allow a user to understand one or more risks (and one or more controls that may mitigate those risks) associated with an entity.

Calculation device 14 may calculate the residual risk score for the entity using calculation rules 34. Residual risk score for the entity may be calculated using any suitable rule in calculation rules 34. As an example of such a calculation, the residual risk score for the entity may be calculated as a weighted average of each of the residual risk scores for the processes of the entity. For example, when the first process of company XYZ (i.e., manufacturing the product) has a residual risk score of 50 and a process weight of 40%, and each of the other three processes of company XYZ (i.e., marketing the product; selling the product; and researching future products) have a residual risk score of 70 and a process weight of 20%, the residual risk score for company XYZ is 62 ((50*0.4)+(70*0.2)+(70*0.2)+(70*0.2)=62). An example of the residual risk score for the entity may be seen at indicator 120 of FIGS. 2A-2E.

Although the residual risk score for the entity has been discussed above as being a numerical value, in particular embodiments, the residual risk score for the entity may further be calculated as a level (i.e., high, moderate, low). For example, a residual risk score for the entity that is less than 12 may be calculated as a “low” residual risk score, a residual risk score for the entity that is greater than or equal to 12 and less than 75 may be calculated as a “moderate” residual risk score, and a residual risk score for the entity that is greater than or equal to 75 may be calculated as a “high” residual risk score. As such, when the residual risk score for the entity is 62, the residual risk score for the process may be calculated to be a “moderate” residual risk score for the entity.

Sixteenth, based on one or more of the calculations and determinations made by calculation device 14, calculation device 14 may communicate results 112 of one or more of the calculations and/or determinations for display to a user. Results 112 may include any suitable information to be displayed in any suitable format. As an example, results 112 may include an indication of the residual risk score for the entity. As another example, results 112 may include an indication of the residual risk for one or more of the processes. As a further example, results 112 may include images representing the processes associated with the entity and images representing the process groupings associated with the entity. Additionally, results 112 may include any of the other determinations and/or calculations made by calculation device 14. Furthermore, based on results 112, user device 54 may display results 112 on graphical user interface 56. As such, a user of user device 54 may be able to understand one or more risks (and one or more controls that may mitigate those risks) associated with an entity and/or a process of any entity. Example results 112 communicated by calculation device 14 and displayed to the user are discussed below with regard to FIGS. 2A-2E and 3.

Modifications, additions, or omissions may be made to system 10 without departing from the scope of the invention. For example, the determinations and calculations performed by calculation device 14 may be performed without receiving a request from a user or a selection by a user. As such, if a user does later request to view a particular residual risk score, for example, the residual risk score may have already been calculated, and may be communicated without any further calculations. Additionally, system 10 may include any number of calculation devices 14, networks 46, administration devices 50, user devices 54, and/or data sources 58. Any suitable logic may perform the functions of system 10 and the components within system 10.

Although system 10 has been described above as including a calculation device 14 that may perform various determinations and calculations for an entity, processes, risks, and/or controls according to one embodiment, in other embodiments, such calculations and determinations may be made in other suitable manners. For example, as is discussed above, each control may be associated with a particular region (such as the USA, EMEA, Asia, etc.), and each risk may also be associated with a region (such as the USA, EMEA, Asia, etc.). In such an example, the determinations and calculations regarding the controls and risks may be performed by calculation device 14 based on one or more of the regions, as is discussed below. Furthermore, these determinations and calculations may be based on inputs 38, information 108 received from data sources 58, information received from request 100, and/or selections made in selection message 104.

First, calculation device 14 may determine the regions associated with the control and the risk. For example, the risk of lack of supplies for manufacturing the product may be applicable to the USA, EMEA, and Asia, and each of the controls implemented to mitigate the risk may also be applicable to the USA, EMEA, and Asia.

Second, for one or more of the regions, calculation device 14 may determine a control region weighting score for the control in the region. The control region weighting score may represent the weight that is allocated to that control for mitigating a portion of a risk in that particular region. For example, although the control for providing a six month inventory stock pile of supplies may be applicable to the USA, EMEA and Asia, the control may be more applicable to the USA than the EMEA or Asia. As such, the control may be determined to have a control region weighting score of 60% in the USA, a control region weighting score of 20% in the EMEA, and control region weighting score of 20% in Asia.

Third, calculation device 14 may calculate a rating score for the control in the region. The rating score for the control in the region may represent a rating for the control in the region based on its design rating score in the region and its performance rating score in the region. The rating score for the control in the region may be calculated in the same manner as is discussed above with regard to the rating score for the control. For example, the rating score for the control in the region may be calculated based on a design rating score for the control in the region and a performance rating score for the control in the region, as is discussed above.

Fourth, calculation device 14 may calculate a region score for the control in the region. The region score for the control in the region represents the score that may be utilized by calculation device 14 to calculate the residual risk score for the risk in the region, as is discussed below. For example, the region score for the control in the USA may be utilized by calculation device 14 to calculate the residual risk score for the risk in the USA. Calculation device 14 may calculate the region score for the control in the region using calculation rules 34. The region score for the control in the region may be calculated using any suitable rule in calculation rules 34. For example, the region score for the control in the region may be calculated based on the following calculations rule 34:

RS_{cr}=CRWS_{cr}*S_{rcr}*Wₑ (4)
wherein RS_{cr} is the region score for the control in the region
wherein CRWS_{cr} is the control region weighting score for the control in the region
wherein the S_{rcr} is the rating score for the control in the region
wherein W_{c} is the control weight for the control (discussed above as representing the weight that is allocated to the control for mitigating a portion of a risk)

Fifth, for each of the regions associated with one or more of the risks, calculation device 14 may calculate an inherent risk score for the risk in the region. The inherent risk score for the risk in the region represents an indication of the severity of the risk in the region absent any controls. The inherent risk score for the risk in the region may be calculated in the same manner as is discussed above with regard to the inherent risk score for the risk. For example, the inherent risk score for the risk in the region may be calculated based on a impact score for the risk in the region and a probability score for the risk in the region, as is discussed above.

Sixth, for each of the regions associated with one or more of the risks, calculation device 14 may calculate a residual risk score for the risk in the region. The residual risk score for the risk in the region represents an indication of a severity of the risk in the region when the risk is mitigated by one or more controls. Calculation device 14 may calculate the residual risk score for the risk in the region using calculation rules 34. The residual risk score for the risk in the region may be calculated using any suitable rule in calculation rules 34. For example, the residual risk score for the risk in the region may be calculated based on the following calculation rule 34:

RRSᵣᵣ=(IRSᵣ*C₁ᵣ)+(IRS*C₂ᵣ)+ . . . (5)
wherein RRSᵣᵣ is the residual risk score for the risk in the region
wherein IRSᵣ is the inherent risk score for the risk in the region
wherein C₁ᵣ is the region score for the first control implemented to mitigate a portion of the risk in the region
wherein C₂ᵣ is the region score for the second control implemented to mitigate a portion of the risk in the region

Seventh, for each of the regions associated with one or more of the risks, calculation device 14 may determine a risk region weighting score for the risk in the region. The risk region weighting score for the risk in the region may represent the weight that is allocated to that risk in that particular region for calculating a residual risk score for the risk. For example, although the risk of lack of supplies for manufacturing the product may be applicable to the USA, EMEA and Asia, the risk may be more applicable to the entity in the USA than in the EMEA or Asia. As such, the risk may be determined to have a risk region weighting score of 50% in the USA, a risk region weighting score of 25% in the EMEA, and a risk region weighting score of 25% in Asia.

Eighth, calculation device 14 may calculate the residual risk score for the risk (as opposed to the residual risk score for the risk in the region, discussed above). The residual risk score for the risk represents an indication of a severity of the risk (in all of the regions) when the risk is mitigated by one or more controls. Calculation device 14 may calculate the residual risk score for the risk using calculation rules 34. The residual risk score for the risk may be calculated using any suitable rule in calculation rules 34. For example, the residual risk score for the risk may be calculated as a weighted average of each of the residual risk scores for the risk in each of the regions. For example, when the USA region has a residual risk score for the risk of 36 and a risk region weighting score of 50%, the EMEA has a residual score for the risk of 20 and a risk region weighting score of 25%, and Asia has a residual risk score for the risk of 20 and a risk region weighting score of 25%, the residual risk score for the risk is 28 ((36*0.50)+(20*0.25)+(20*0.25)=28).

Ninth, as is discussed in detail above, calculation device 14 may then perform one or more of the following functions: calculate one or more of the residual risk score for the process, calculate the trend direction of the residual risk score for the process, determine a process weight associated with the process, calculate a residual risk score for the entity, and communicate results 112 of one or more of the calculations and/or determinations for display to a user. Example results 112 communicated by calculation device 14 and displayed to the user are discussed below with regard to FIGS. 2A-2E and 3.

FIGS. 2A-2E illustrate an example display 116 according to one embodiment of the present disclosure. Display 116 includes one or more of the calculations and determinations performed by calculation device 14 of FIG. 1. Display 116 may be displayed to a user using a user device, such as user device 54a of FIG. 1. Display 116 may be displayed to a user in response to the user providing a request for information included in display 116, in particular embodiments.

According to the illustrated embodiment, display 116 includes an indication 120 of the residual risk score for the entity. The indication 120 of the residual risk score for the entity may include any suitable indication. For example, the indication 120 of the residual risk score for the entity may be a numerical indication, a color-based indication, a level-based indication (i.e., high, low, moderate), any other indication of the residual risk score, or any combination of the preceding. According to the illustrated embodiment, the indication 120 of the residual risk score for the entity includes both a numerical indication and a color-based indication. For example, the numerical indication includes a numerical value of 8.53. As a further example, the color-based indication includes a box surrounding the numerical indication and having a first color, such as, for example, green. The color of the color-based indication may be based on a level of the residual risk score for the entity (calculated above). For example, if the level of the residual risk score for the entity is “high,” the color-based indication may be a first color, such as, for example, red. As another example, if the level of the residual risk score for the entity is “moderate,” the color-based indication may be a second color, such as, for example, yellow. As a further example, if the level of the residual risk score for the entity is “low,” the color-based indication may be a third color, such as green.

Display 116 further includes information regarding the process groupings associated with the entity and the processes associated with the entity. As illustrated, display 116 includes images representing the process groupings associated with the entity and images representing the processes associated with the entity. As an example of these images, display 116 includes a process grouping image 124 for the process grouping entitled “3.0 Sales & Relationship Management,” and process images 128a-128e, entitled “3.3 Manage Sales,” “3.4 Authorized Client,” “3.7 Communicate With Client,” “3.11 Establish Client Account,” and “3.16 Manage Client Interfaces.” Process images 128a-128e each represent processes that are associated with the process grouping “3.0 Sales & Relationship Management” (which is represented by process grouping image 124). Furthermore, each of the process images 128a-128e are arranged within the process grouping image 124. Such an arrangement may provide an easily understood representation of the processes and process groupings of an entity, in particular embodiments.

Display 116 further includes indications of the residual risk score for one or more processes. As an example of these indications, display 116 includes the indication 132 of the residual risk score for the process “3.3 Manage Sales.” The indication 132 of the residual risk score for the process may include any suitable indication. For example, the indication 132 of the residual risk score for the process may be a numerical indication, a color-based indication, a level-based indication (i.e., high, low, moderate), any other indication of the residual risk score, or any combination of the preceding. According to the illustrated embodiment, the indication 132 of the residual risk score for the process includes both a numerical indication and a color-based indication. For example, the numerical indication includes a numerical value of 8.0. As a further example, the color-based indication includes a box located inside of image 128a and having a first color, such as, for example, green. The color of the color-based indication may be based on a level of the residual risk score for the process (calculated above). For example, if the level of the residual risk score for the process is “high,” the color-based indication may be a first color, such as, for example, red. As another example, if the level of the residual risk score for the process is “moderate,” the color-based indication may be a second color, such as, for example, yellow. As a further example, if the level of the residual risk score for the process is “low,” the color-based indication may be a third color, such as green.

Display 116 further includes indications of trend direction of the residual risk for one or more processes. As an example of such indications, display 116 includes indication 136 of the trend direction of the residual risk for the process “3.3 Manage Sales.” The indication 136 of the trend direction of the residual risk for the process may include any suitable indication. For example, indication 136 of the trend direction may include a graphical representation of the trend direction, a description of the trend direction (i.e., increasing, decreasing, consistent), any other suitable indication of the trend direction, or any combination of the preceding. According to the illustrated embodiment, the indication 136 of the trend direction includes a graphical representation of the trend direction (i.e., ↑, ↓, ←, or →). The graphical representation of the trend direction of indication 136 may be based on the calculated trend direction of the residual risk score for the process (calculated above). For example, if the trend direction of the residual risk score for the process is increasing, indication 136 of the trend direction may be a first graphical representation, such as, for example, ↑. As another example, if the trend direction of the residual risk score for the process is decreasing, indication 136 of the trend direction may be a second graphical representation, such as, for example, ↓. As a further example, if the trend direction of the residual risk score for the process is consistent, indication 136 of the trend direction may be a third graphical representation, such as, for example, → or ←).

Display 116 may further include indications of any other determinations and/or calculations performed by calculation device 14. As a first example, display 116 includes an indication 140 of the process weight associated with the process (determined above). As illustrated, the indication 140 indicates a process weight of 0.39% for the process “3.3 Manage Sales.” As a second example, display 116 further includes an indication 144 of a key control indicator associated with a control of a process. The indication 144 may include any suitable graphical representation of a key control indicator. As illustrated, the indication 144 includes an exclamation point that indicates that there is a key control indicator associated with a control of the process. Furthermore, indication 144 may further include a color-based indication (i.e., such as a colored box that surrounds the exclamation point) that may change colors based on the status of the key control indicator. As a third example, display 116 further includes indication 148 of an issue associated with control of a process. The indication 148 may include any suitable graphical representation of an issue. As illustrated, the indication 148 includes a flag that indicates that there is an issue associated with a control of the process. Furthermore, indication 148 may further include a color-based indication (i.e., such as a colored box that surrounds the flag) that may change colors based on the status of the issue.

In addition to displaying one or more determinations and/or calculations performed by calculation device 14, display 116 may further allow a user to navigate through the displayed determinations and/or calculations. For example, one or more of the images, indications, and/or information displayed in display 116 may be clicked on by a user, resulting in additional information being displayed regarding the image, indication, and/or information. For example, a user may click on indication 144 of a key control indicator, resulting in information regarding the key control indicator being displayed to the user (i.e., such as displayed in display 116 or in another graphical user interface). As another example, a user may be able to select (and/or filter) which information is displayed in display 116. In such an example, a user may select a particular entity, thereby causing display 116 to only display information regarding that entity. Furthermore, the information regarding that entity may be further filtered based on a particular process, process grouping, any other level of information regarding the entity, or any combination of the preceding.

FIG. 3 illustrates an example display 200 according to one embodiment of the present disclosure. Display 200 includes one or more of the calculations and/or determinations performed by calculation device 14 of FIG. 1. Display 200 may be displayed to a user using a user device such as user device 54a of FIG. 1. In particular embodiments, display 200 may be displayed to a user in response to the user providing a request for the information included in display 200. As an example, display 200 may be displayed to a user in response to a user clicking on the image representing the process entitled “5.1 Capture & Validate Transaction” in display 116 of FIGS. 2A-2E.

As illustrated, display 200 includes an indication 232 of the residual risk score for the process, indication 236 of the trend direction of the residual risk score for the process, indication 240 of the process weight associated with the process, indication 244 of a key control indicator associated with a control of the process, and indication 248 of an issue associated with a control of a process. In particular embodiments, each of these indications may be substantially similar to indications 132, 136, 140, 144, and 148 of display 116 of FIGS. 2A-2E.

Display 200 further includes risk entry 250. Risk entry 250 provides a display or one or more risks associated with the process. For example, risk entry 250 provides a display of the risk “Cancels/Corrects & Amends.” Furthermore, risk entry 250 includes information related to each risk. For example, risk entry 250 includes region entries 252a-252c, which indicate what regions are applicable to the risk. As another example, risk entry 250 further includes an impact score column 256, a probability score column 260, a key risk indicator column 264, an inherent risk score column 268, residual risk score column 272, a trend direction column 276, an accept the risk column 280, and a weighting column 284. Each of these columns 256-284 provide an indication of a determination and/or a calculation performed by calculation device 14. For example, with regard to the region indicator 252a for the USA region, columns 256-284 provide an indication of an impact score for the risk in the USA (column 256), a probability score for the risk in the USA (column 260), whether or not the risk is associated with a key risk indicator in the USA (column 264), an inherent risk score for the risk in the USA (column 268), a residual risk score for the risk in the USA (column 272), a trend direction indication for the risk in the USA (column 276), whether or not the risk has been accepted in the USA (column 280), and the risk region weighting score for the risk in the USA (column 284). Any of the information displayed in columns 256-284 may be determined (such as, for example, by receiving a selection from a user) and/or calculated by calculation device 14, in particular embodiments.

Control entry 288 provides a display or one or more controls associated with a risk. For example, control entry 288 provides a display of the control “Review Reports For.” Furthermore, control entry 288 includes information related to each control. For example, control entry 288 includes region entries 292a-292c, which indicate what regions are applicable to the control. As another example, control entry 288 further includes a type column 296, a design rating score column 300, a performance rating score 304, a rating score column 308, a loss column 312, an issue column 316, an indicator column 320, and a test column 324. Each of these columns 296-324 provide an indication of a determination and/or a calculation performed by calculation device 14. For example, with regard to the region indicator 292a for the USA region, columns 296-324 provide an indication of whether the control is for quality control (QC) or quality assurance (QA) in the USA (column 296), a design rating score for the control in the USA (column 300), a performance rating score for the control in the USA (column 304), a rating score for the control in the USA (column 308), whether or not a loss is associated with the control in the USA (column 312), whether or not an issue is associated with the control in the USA (column 316), whether or not a key control indicator is associated with the control in the USA (column 320), and whether or not the control has been tested in the USA (column 324). Any of the information displayed in columns 296-324 may be determined (such as, for example, by receiving a selection from a user) and/or calculated by calculation device 14, in particular embodiments.

In addition to displaying one or more determinations and/or calculations performed by calculation device 14, display 200 may further allow a user to navigate through the displayed determinations and/or calculations. For example, one or more of the images, indications, and/or information displayed in display 200 may be clicked on by a user, resulting in additional information being displayed regarding the image, indication, and/or information. In such an example, a user may click on indication 244 of a key control indicator, resulting in information regarding the key control indicator being displayed to the user (i.e., such as displayed in display 200 or in another graphical user interface). As another example, a user may be able to click on one or more of columns 256-284 and/or 296-324 in order to change the information displayed in the column. In such an example, the user may click on an area in impact score column 256 in order to input (or otherwise select, such as using selection message 104) the impact score for that particular risk. Furthermore, any changes made by calculation device 14 (or by a user clicking in any of the columns of display 200) may automatically cause various other portions of display 200 to be updated (in, for example, real time or near real time (i.e., such as real time plus calculation time)). Therefore, if a user or calculation device 114 updates the impact score for a risk, the inherent risk score for the risk may be automatically updated, the residual risk score for the risk may be automatically updated, the trend direction for the risk may be automatically updated, the residual risk score for the process may be automatically updated, the trend direction for the process may be automatically updated, the residual risk score for the entity may be automatically updated (shown is display 116), any other information may be automatically updated (including any information in display 116 of FIGS. 2A-2E), or any combination of the preceding.

As a further example, a user and/or calculation device 14 may make changes to any of the portions of display 200 (and/or display 116), and those changes may be saved as an interim file. As such, the original file may also exist (i.e., the calculations and/or determinations before the changes) and the interim file may exist (i.e., the calculations and/or determinations after the changes). This may allow a user and/or calculation device 14 to run sample simulations of different information for controls, risks, and/or entities, thereby enabling a user to see how different changes may effect residual risk scores. Thus, a user may be able to determine which processes, risks, and/or controls have the greatest effect on a residual risk score, and, as a result, focus the entity's resources on those particular processes, risks, and/or controls in order to reduce the risk associated with the entity and/or a process.

Although the present disclosure has been described with several embodiments, a myriad of changes, variations, alterations, transformations, and modifications may be suggested to one skilled in the art, and it is intended that the present disclosure encompass such changes, variations, alterations, transformations, and modifications as fall within the scope of the appended claims.

What is claimed is:

1. A system, comprising:
a memory operable to store a plurality of calculation rules;
a processor communicatively coupled to the memory and operable to:
determine an entity;
determine a plurality of process groupings associated with the entity;
determine a plurality of processes associated with the entity, a process being associated with at least one of the process groupings and comprising an activity of a portion of the entity;
determine a plurality of risks associated with the entity, a risk being associated with at least one of the processes;
determine a plurality of controls associated with the entity, a control being associated with at least one of the risks and configured to mitigate a portion of the associated risk;
for each of the controls, calculate, based on the calculation rules, one or more weighted control scores for the control;
for each of the risks:
calculate, based on the calculation rules, an inherent risk score for the risk, the inherent risk score comprising an indication of a first severity of the risk absent any of the controls associated with the risk;
calculate, based on the calculation rules, a residual risk score for the risk using at least the inherent risk score for the risk and the weighted control scores for each of the controls associated with the risk, the residual risk score comprising an indication of a second severity of the risk including each of the controls associated with the risk; and
for each of the processes, calculate, based on the calculation rules, a residual risk score for the process using each of the residual risk scores of the risks associated with the process; and
an interface communicatively coupled to the processor and operable to communicate for display:
for each of the process groupings, an image representing the process grouping;
for each of the processes:
an image representing the process, wherein the image representing the process is arranged within the image representing the process grouping that the process is associated with; and
an indication of the residual risk score for the process, wherein the indication of the residual risk score for the process is arranged within the image representing the process.

2. The system of claim 1, wherein the indication of the residual risk score for the process comprises one or more of:
a numerical indication of the residual risk score for the process; and
a color-based indication of the residual risk score for the process.

3. The system of claim 1, wherein:
the processor is further operable to calculate, based on the calculation rules, a level of the residual risk score for the process, the level comprising a selected one of:
high;
moderate; and
low;
the indication of the residual risk score for the process comprises a color-based indication of the residual risk score for the process; and
the color-based indication comprises a selected one of:
a first color in response to the calculated high level;
a second color in response to the calculated moderate level; and
a third color in response to the calculated low level.

4. The system of claim 1, wherein:
the processor is further operable to calculate, based on the calculation rules, a trend direction of the residual risk score for the process using the residual risk score for the process and at least one previous residual risk score for the process, the trend direction comprising a selected one of:
increasing;
decreasing; and
consistent; and
the interface is further operable to communicate for display an indication of the trend direction of the residual risk score for the process, wherein the indication of the trend direction of the residual risk score for the process is arranged within the image representing the process, wherein the indication of the trend direction of the residual risk score for the process comprises a selected one of:
a first graphical representation in response to the calculated increasing trend direction;
a second graphical representation in response to the calculated decreasing trend direction; and
a third graphical representation in response to the calculated consistent trend direction.

5. The system of claim 1, wherein the processor is further operable to:
for each of one or more of the controls:
determine a plurality of regions associated with the control;
for each of the regions associated with the control:
determine a control region weighting score for the control in the region;
calculate, based on the calculation rules, a rating score for the control in the region; and
calculate, based on the calculation rules, a region score for the control in the region using the control region weighting score for the control in the region, the rating score for the control in the region, and a control weight for the control, wherein the one or more weighted control scores for the control comprises each of the region scores for the control;
for each of one or more of the risks:
determine a plurality of regions associated with the risk;
for each of the regions associated with the risk:
determine a risk region weighting score for the risk in the region;
calculate, based on the calculation rules, an inherent risk score for the risk in the region;
calculate, based on the calculation rules, a residual risk score for the risk in the region using at least the inherent risk score for the risk in the region and the region score for the region for each of the controls associated with the risk; and
calculate, based on the calculation rules, the residual risk score for the risk using the residual risk score for the risk in each of the regions and the risk region weighting scores for each of the regions.

6. The system of claim 1, wherein:
for each of the controls associated with each of the risks:
the processor is further operable to determine whether the control is associated with a key control indicator; and
in response to the determination that the control is associated with the key control indicator, the interface is further operable to communicate for display an indication of the key control indicator, wherein the indication of the key control indicator is arranged within the image representing the process that the associated risk is associated with.

7. The system of claim 1, wherein:
for each of the controls associated with each of the risks:
the processor is further operable to determine whether the control is associated with an issue; and
in response to the determination that the control is associated with the issue, the interface is further operable to communicate for display an indication of the issue, wherein the indication of the issue is arranged within the image representing the process that the associated risk is associated with.

8. A non-transitory computer readable medium comprising logic, the logic, when executed by a processor, operable to:
store a plurality of calculation rules;
determine an entity;
determine a plurality of process groupings associated with the entity;
determine a plurality of processes associated with the entity, a process being associated with at least one of the process groupings and comprising an activity of a portion of the entity;
determine a plurality of risks associated with the entity, a risk being associated with at least one of the processes;
determine a plurality of controls associated with the entity, a control being associated with at least one of the risks and configured to mitigate a portion of the associated risk;
for each of the controls, calculate, based on the calculation rules, one or more weighted control scores for the control;
for each of the risks:
calculate, based on the calculation rules, an inherent risk score for the risk, the inherent risk score comprising an indication of a first severity of the risk absent any of the controls associated with the risk;
calculate, based on the calculation rules, a residual risk score for the risk using at least the inherent risk score for the risk and the weighted control scores for each of the controls associated with the risk, the residual risk score comprising an indication of a second severity of the risk including each of the controls associated with the risk;
for each of the processes, calculate, based on the calculation rules, a residual risk score for the process using each of the residual risk scores of the risks associated with the process; and
communicate for display:
for each of the process groupings, an image representing the process grouping;
for each of the processes:
an image representing the process, wherein the image representing the process is arranged within the image representing the process grouping that the process is associated with; and
an indication of the residual risk score for the process, wherein the indication of the residual risk score for the process is arranged within the image representing the process.

9. The computer readable medium of claim 8, wherein the indication of the residual risk score for the process comprises one or more of:
a numerical indication of the residual risk score for the process; and
a color-based indication of the residual risk score for the process.

10. The computer readable medium of claim 8, wherein:
the logic, when executed by the processor, is further operable to calculate, based on the calculation rules, a level of the residual risk score for the process, the level comprising a selected one of:
high;
moderate; and
low;
the indication of the residual risk score for the process comprises a color-based indication of the residual risk score for the process; and
the color-based indication comprises a selected one of:
a first color in response to the calculated high level;
a second color in response to the calculated moderate level; and
a third color in response to the calculated low level.

11. The computer readable medium of claim 8, wherein the logic, when executed by the processor, is further operable to:
calculate, based on the calculation rules, a trend direction of the residual risk score for the process using the residual risk score for the process and at least one previous residual risk score for the process, the trend direction comprising a selected one of:
increasing;
decreasing; and
consistent; and
communicate for display an indication of the trend direction of the residual risk score for the process, wherein the indication of the trend direction of the residual risk score for the process is arranged within the image representing the process, wherein the indication of the trend direction of the residual risk score for the process comprises a selected one of:
a first graphical representation in response to the calculated increasing trend direction;
a second graphical representation in response to the calculated decreasing trend direction; and
a third graphical representation in response to the calculated consistent trend direction.

12. The computer readable medium of claim 8, wherein the logic, when executed by the processor, is further operable to:
for each of one or more of the controls:
determine a plurality of regions associated with the control;
for each of the regions associated with the control:
determine a control region weighting score for the control in the region;
calculate, based on the calculation rules, a rating score for the control in the region; and
calculate, based on the calculation rules, a region score for the control in the region using the control region weighting score for the control in the region, the rating score for the control in the region, and a control weight for the control, wherein the one or more weighted control scores for the control comprises each of the region scores for the control;
for each of one or more of the risks:
determine a plurality of regions associated with the risk;
for each of the regions associated with the risk:
determine a risk region weighting score for the risk in the region;
calculate, based on the calculation rules, an inherent risk score for the risk in the region;
calculate, based on the calculation rules, a residual risk score for the risk in the region using at least the inherent risk score for the risk in the region and the region score for the region for each of the controls associated with the risk; and
calculate, based on the calculation rules, the residual risk score for the risk using the residual risk score for the risk in each of the regions and the risk region weighting scores for each of the regions.

13. The computer readable medium of claim 8, wherein the logic, when executed by the processor, is further operable to:
for each of the controls associated with each of the risks:
determine whether the control is associated with a key control indicator; and
in response to the determination that the control is associated with the key control indicator, communicate for display an indication of the key control indicator, wherein the indication of the key control indicator is arranged within the image representing the process that the associated risk is associated with.

14. The computer readable medium of claim 8, wherein the logic, when executed by the processor, is further operable to:
for each of the controls associated with each of the risks:
determine whether the control is associated with an issue; and
in response to the determination that the control is associated with the issue, communicate for display an indication of the issue, wherein the indication of the issue is arranged within the image representing the process that the associated risk is associated with.

15. A method, comprising:
storing, using one or more processors, a plurality of calculation rules;
determining, using the one or more processors, an entity;
determining, using the one or more processors, a plurality of process groupings associated with the entity;
determining, using the one or more processors, a plurality of processes associated with the entity, a process being associated with at least one of the process groupings and comprising an activity of a portion of the entity;
determining, using the one or more processors, a plurality of risks associated with the entity, a risk being associated with at least one of the processes;
determining, using the one or more processors, a plurality of controls associated with the entity, a control being associated with at least one of the risks and configured to mitigate a portion of the associated risk;
for each of the controls, calculating, using the one or more processors and based on the calculation rules, one or more weighted control scores for the control;
for each of the risks:
calculating, using the one or more processors and based on the calculation rules, an inherent risk score for the risk, the inherent risk score comprising an indication of a first severity of the risk absent any of the controls associated with the risk;
calculating, using the one or more processors and based on the calculation rules, a residual risk score for the risk using at least the inherent risk score for the risk and the weighted control scores for each of the controls associated with the risk, the residual risk score comprising an indication of a second severity of the risk including each of the controls associated with the risk; and
for each of the processes, calculating, using the one or more processors and based on the calculation rules, a residual risk score for the process using each of the residual risk scores of the risks associated with the process; and
communicating, using the one or more processors, for display:
for each of the process groupings, an image representing the process grouping;
for each of the processes:
an image representing the process, wherein the image representing the process is arranged within the image representing the process grouping that the process is associated with; and
an indication of the residual risk score for the process, wherein the indication of the residual risk score for the process is arranged within the image representing the process.

16. The method of claim 15, wherein the indication of the residual risk score for the process comprises one or more of:
a numerical indication of the residual risk score for the process; and
a color-based indication of the residual risk score for the process.

17. The method of claim 15, wherein:
the method further comprises calculating, using the one or more processors and based on the calculation rules, a level of the residual risk score for the process, the level comprising a selected one of:
high;
moderate; and
low;
the indication of the residual risk score for the process comprises a color-based indication of the residual risk score for the process; and
the color-based indication comprises a selected one of:
a first color in response to the calculated high level;
a second color in response to the calculated moderate level; and
a third color in response to the calculated low level.

18. The method of claim 15, further comprising:
calculating, using the one or more processors and based on the calculation rules, a trend direction of the residual risk score for the process using the residual risk score for the process and at least one previous residual risk score for the process, the trend direction comprising a selected one of:
increasing;
decreasing; and
consistent; and
communicating, using the one or more processors, for display an indication of the trend direction of the residual risk score for the process, wherein the indication of the trend direction of the residual risk score for the process is arranged within the image representing the process, wherein the indication of the trend direction of the residual risk score for the process comprises a selected one of:
a first graphical representation in response to the calculated increasing trend direction;
a second graphical representation in response to the calculated decreasing trend direction; and
a third graphical representation in response to the calculated consistent trend direction.

19. The method of claim 15, further comprising:
for each of one or more of the controls:
determining, using the one or more processors, a plurality of regions associated with the control;
for each of the regions associated with the control:
determining, using the one or more processors, a control region weighting score for the control in the region;
calculating, using the one or more processors and based on the calculation rules, a rating score for the control in the region; and
calculating, using the one or more processors and based on the calculation rules, a region score for the control in the region using the control region weighting score for the control in the region, the rating score for the control in the region, and a control weight for the control, wherein the one or more weighted control scores for the control comprises each of the region scores for the control;
for each of one or more of the risks:
determining, using the one or more processors, a plurality of regions associated with the risk;
for each of the regions associated with the risk:
determining, using the one or more processors, a risk region weighting score for the risk in the region;
calculating, using the one or more processors and based on the calculation rules, an inherent risk score for the risk in the region;
calculating, using the one or more processors and based on the calculation rules, a residual risk score for the risk in the region using at least the inherent risk score for the risk in the region and the region score for the region for each of the controls associated with the risk; and
calculating, using the one or more processors and based on the calculation rules, the residual risk score for the risk using the residual risk score for the risk in each of the regions and the risk region weighting scores for each of the regions.

20. The method of claim 15, further comprising:
for each of the controls associated with each of the risks:
determining, using the one or more processors, whether the control is associated with a key control indicator; and
in response to the determination that the control is associated with the key control indicator, communicating, using the one or more processors, for display an indication of the key control indicator, wherein the indication of the key control indicator is arranged within the image representing the process that the associated risk is associated with.
